(19) United States
(12) Patent Application Publication
(10) Pub. No.: US 2010/0088412 A1
(43) Pub. Date: Apr. 8, 2010

(54) CAPACITY SIZING A SIP APPLICATION SERVER BASED ON MEMORY AND CPU CONSIDERATIONS

(75) Inventors: GARY J. DEVAL, RALEIGH, NC (US); CURTIS E. HRISCHUK, HOLLY SPRINGS, NC (US); TIMOTHY P. PICKETT, ROCHESTER, MN (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/246,611

(22) Filed: Oct. 7, 2008

(51) Int. Cl. G06F 15/173

(52) U.S. Cl. 709/226

(57) ABSTRACT

A SIP workload can be defined. A number of nodes of a SIP application server needed to handle the SIP workload can be determined based upon memory considerations. A number of nodes of the SIP application server needed to handle the SIP workload can be determined base upon CPU considerations. The SIP application server can be capacity sized based upon a greater of the determined number of nodes based upon memory consideration and the determined number of nodes based upon CPU considerations.

### BACKGROUND

The present invention relates to the field of capacity sizing a Session Initiation Protocol (SIP) application server and, more particularly, to capacity sizing a SIP application server based on memory and CPU considerations.

A discrepancy between a capacity of a set of purposed computing resources (generically a computing environment) and a workload handled by the computing environment results in inefficiency. This inefficiency can be an under-utilization of available resources, which incurs an unnecessary high infrastructure cost, or can be an over-utilization of available resources, which results in the workload being handled poorly. Capacity sizing attempts to establish a minimal computing environment for handling a maximum anticipated workload, which minimizes inefficiency.

Different types of workload and environments have different capacity sizing issues. The present disclosure concerns capacity sizing of a SIP workload. Existing solutions focus upon network issues with a SIP workload, such as bandwidth, numbers of gateway trunks, number of interactive voice response (IVR) ports to handle a load, traffic flows, and the like. Existing capacity sizing for a SIP workload has not focused upon capacity sizing a cluster of JAVA Enterprise Edition (Java EE) Application servers. Existing configuration sizing approaches for a SIP workload lack a notion of a CPU being a potential bottleneck. No known capacity sizing approach of a Java EE application server for a SIP workload includes both memory and CPU constraints.

### BRIEF DESCRIPTION OF THE SEVERAL VIEWS OF THE DRAWINGS

FIG. 1 is a flowchart of a method for capacity sizing a Session Initiation Protocol (SIP) application server based upon memory and CPU considerations in accordance with an embodiment of the inventive arrangements disclosed herein.

FIG. 2 is a schematic diagram of a system for capacity sizing a SIP application server based upon memory and CPU considerations in accordance with an embodiment of the inventive arrangements disclosed herein.

FIG. 3A shows a sample SIP application server sizing questionnaire including environment parameters and node calculations in accordance with an embodiment of the inventive arrangements disclosed herein.

FIG. 3B shows a sample SIP application server sizing questionnaire including memory constraints in accordance with an embodiment of the inventive arrangements disclosed herein.

FIG. 3C shows a sample SIP application server sizing questionnaire including CPU constraints and SLSP calculations in accordance with an embodiment of the inventive arrangements disclosed herein.

FIG. 3D shows some sample calculations performed to ascertain values placed in the SIP application server sizing questionnaire in accordance with an embodiment of the inventive arrangements disclosed herein.

### DETAILED DESCRIPTION

The disclosure provides a solution for capacity sizing a SIP application server for a SIP workload based upon memory and CPU considerations. In the process, a number of initial measurements can be determined. Formulas can then determine a suitable number of nodes and their configuration to avoid CPU bottlenecks and to avoid memory bottlenecks. Whichever one of these nodes is greater can be used as an optimal number of nodes for the SIP application server given a defined SIP workload.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer usable or computer readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

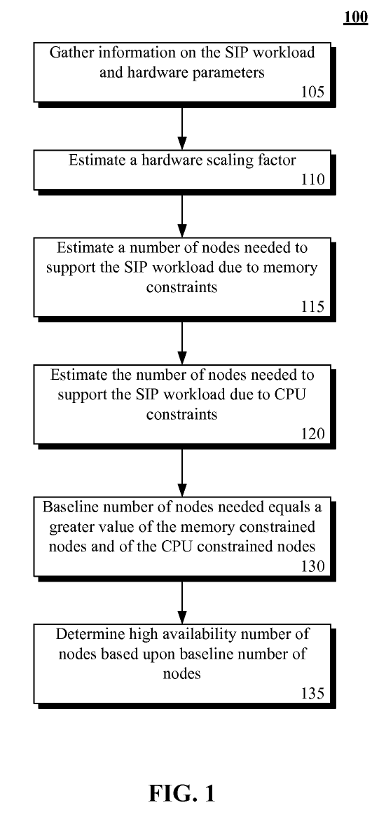

FIG. 1 is a flowchart of a method 100 for capacity sizing a Session Initiation Protocol (SIP) application server based upon memory and CPU considerations in accordance with an embodiment of the inventive arrangements disclosed herein. The SIP application server can be a cluster of physical servers hosting JAVA ENTERPRISE EDITION (Java EE) based application servers that together handle a SIP workload. In one embodiment, the SIP application server can be a high availability server having redundant components that ensure no single point of failure will affect the overall SIP workload. For example, in one embodiment, the SIP application server can be implemented as a WEBSPHERE APPLICATION SERVER NETWORK DEPLOYMENT (WEBSPHERE ND) server. The disclosure is not to be construed as limited in this regard and other implementations for a SIP application server are to be considered within scope of the disclosed solution.

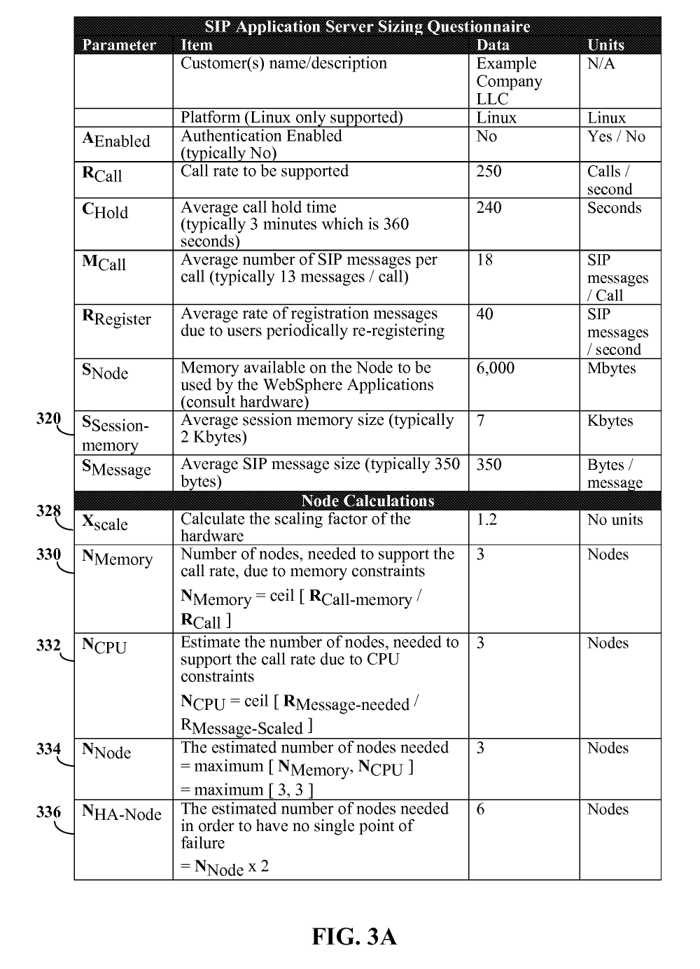

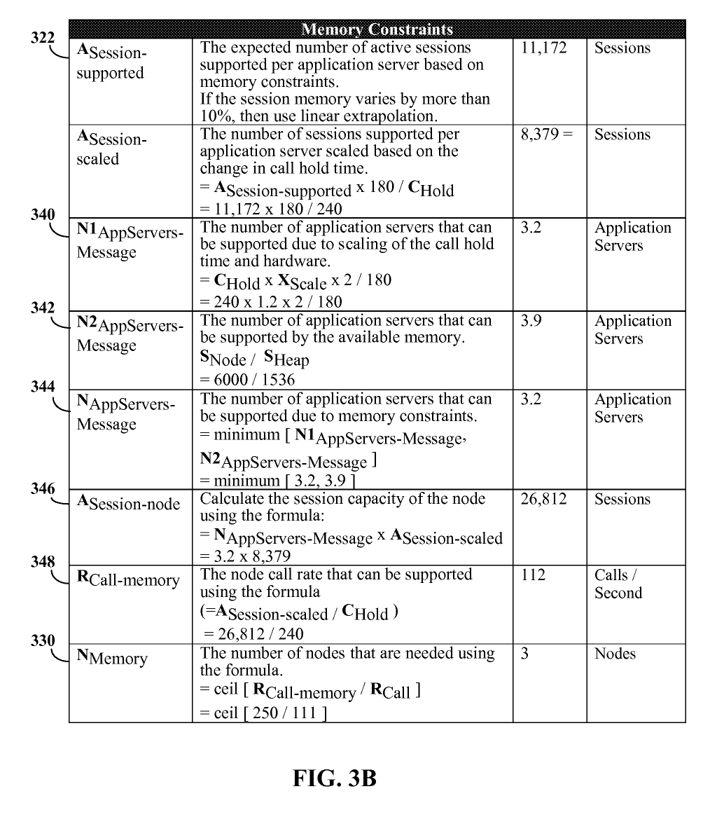

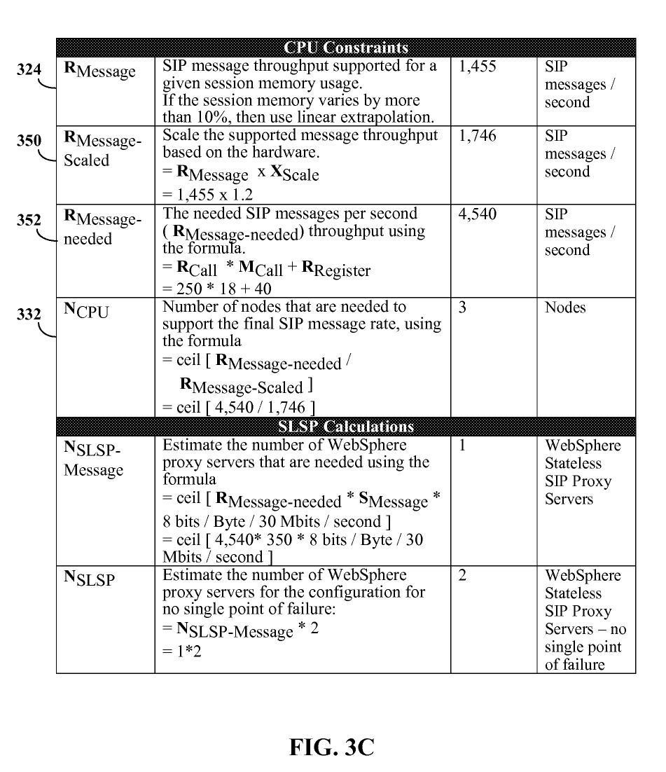

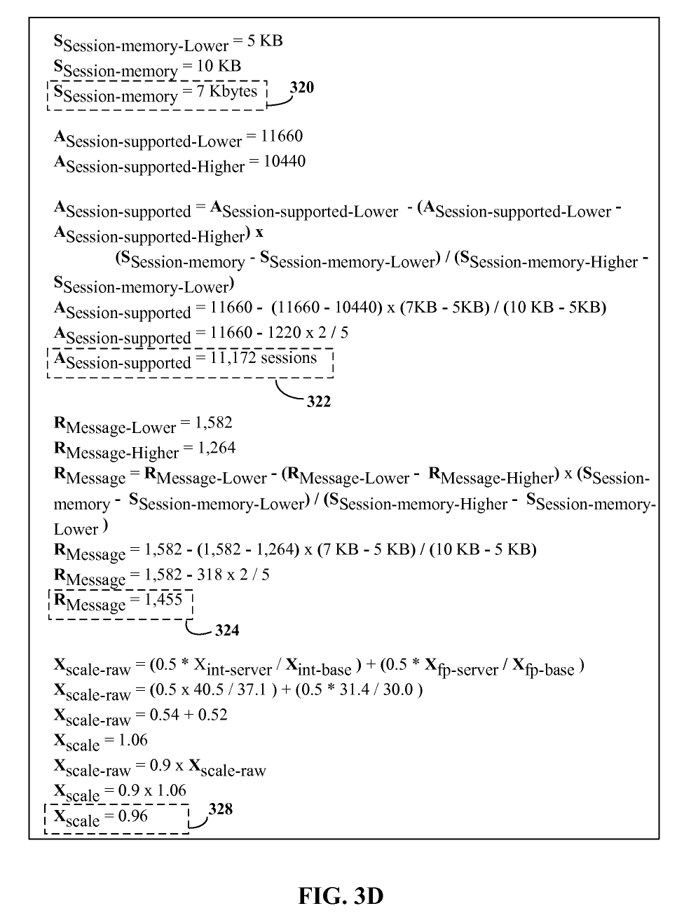

Method 100 can begin in step 105, where information of a SIP workload can be gathered. Hardware parameters of computing resources for supporting the SIP workload can also be gathered at this point. In step 110, a hardware scaling factor can be estimated. An example of a hardware scaling factor (X_{scale} 328 is shown in a table of FIG. 3A and a sample calculation for the same is shown in FIG. 3D.

In step 115, a number of nodes needed to support the SIP workload due to memory constraints can be estimated. A sample of some of these memory constraints is shown in a table of FIG. 3B. Further, item 330 of FIG. 3A shows a sample calculation for performing this estimate.

In step 120, a number of nodes needed to support the SIP workload due to CPU constraints can be estimated. A sample of some of these CPU constraints is shown in a table of FIG. 3C. Further, item 332 of FIG. 3A shows a sample calculation for performing this estimate.

In step 130, a baseline number of nodes needed can be calculated. A sample calculation is shown as item 334 of FIG. 3A, which shows that the baseline number of nodes can be equal to a greater value of the memory constrained nodes and the CPU constrained nodes.

In step 135, a high availability number of nodes can be determined based upon the baseline number of nodes. A sample calculation is shown as item 336 of FIG. 3A, which shows that the high availability number of nodes can be equal to two times the baseline number of nodes.

It should be noted that the equations and calculations of the examples can vary from implementation to implementation. These calculations are included for illustrative purposes only and are not intended to constrain the scope of the disclosure.

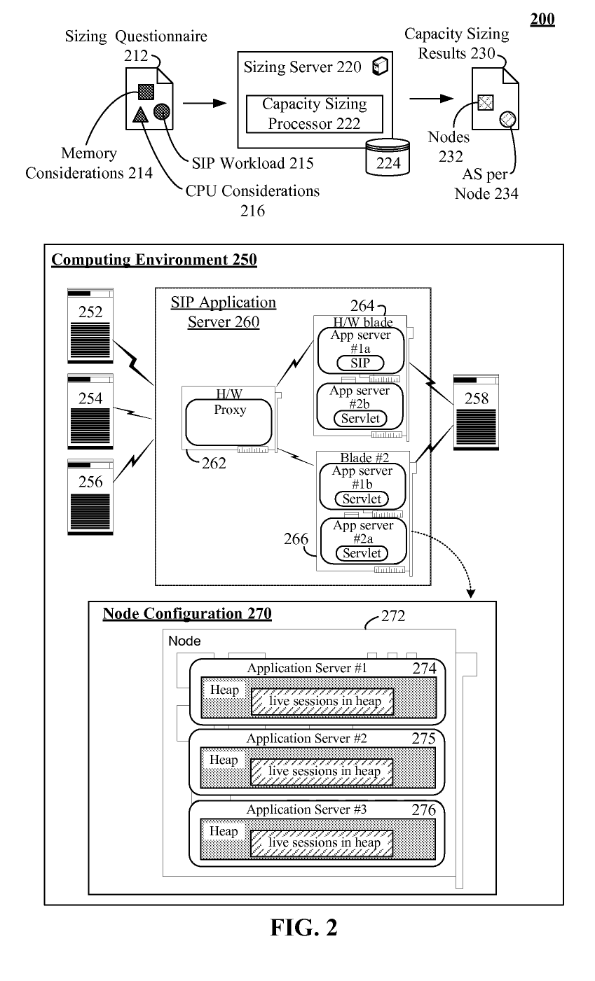

FIG. 2 is a schematic diagram of a system 200 for capacity sizing a SIP application server based upon memory and CPU considerations in accordance with an embodiment of the inventive arrangements disclosed herein. In one embodiment, system 200 can implement the method 100 of FIG. 1. System 200 includes a sizing server 220, which can utilize a capacity sizing processor 222 to generate capacity sizing results 230. The results 230 can be for a computing environment 250 and can be based upon information contained in sizing questionnaire 212.

Although system 200 shows an automated means for producing results 230 (e.g., using server 220), embodiments are contemplated where a human agent manually performs the functions and calculations that are performed by server 220 in the illustrated embodiment. In another embodiment, a human agent can manually perform a portion of the calculations and actions described and another portion can be programmatically performed by server 220. Additionally, although the input used by server 220 is shown as a questionnaire 212 and output in a report format 230, other input and output mechanisms are contemplated. For example, the input 212 can be obtained from user information entered into a user interface of a capacity sizing application. In another embodiment, the input 212 can be automatically obtained from monitoring software agents deployed in environment 250. Similarly, the output 230 can take many forms, such as outputting to a data base, to a result file, to a user interface screen, and the like.

The sizing questionnaire 212 can include data elements for memory considerations 214, for CPU considerations 216, and for SIP workload 215. An example of a questionnaire 212 is shown in FIGS. 3A, 3B, and 3C. Specifics of the example questionnaire (FIGS. 3A, 3B, 3C) are not to be interpreted in a manner that is limiting upon the scope of the disclosure.

The capacity sizing processor 222 can be a software component stored in a storage medium 224, which is executable by server 220. The processor 222 can determine which of the memory considerations 214 and/or CPU considerations 216 is the greatest bottleneck for handling the SIP workload 215. The results 230 produced by processor 222 can include a number of nodes 232 needed for the SIP application server 260 and a number of application servers per node 234.

In one embodiment, the capacity sizing processor 222 can compute the number of application servers per node 234 by first determining a number of application servers that can be supported due to scaling of the call hold time and hardware (N1_{AppServers-Message} shown as item 340). The number of application servers able to be supported by the available memory (N2_{AppServers-Message} shown as item 342) can be calculated. Then a number of application servers that can be supported by a node due to memory constraints can be determined (N_{AppServers-Message} shown as item 344). Appreciably, increasing an amount of RAM within a physical node can affect a quantity of application servers supported per node. Session capacity can then be computed (item 346) as can a node call rate (item 348). The nodes needed as constrained by memory (N_{memory} shown as item 330) can then be calculated.

The capacity sizing processor 222 can compute nodes needed as constrained by CPU as follows. Given SIP message throughput (item 324) a scaled supported message throughput based on hardware (item 350) can be computed. Then, a computation for a number of needed SIP messages per second (item 332) can be performed. The nodes needed as constrained by CPU (item 354) can then be calculated.

Once the two different node values (item 330 and 332) are calculated, processor 222 can calculate an estimated number of nodes needed (item 334). In a high availability context, an additional calculation (item 336) can be performed to adjust the base estimate of nodes (item 334). Sample calculations for computing some of the values relied upon in computing the high availability number of nodes (item 336) are shown in detail in FIG. 3D (e.g., calculation of items 320, 322, 324, and 328). The data fields of the questionnaire tables presented in FIGS. 3A, 3B, 3C are consistent with values used in calculations shown in FIG. 3D. It should be appreciated that the example calculations and values are for illustrative purposes only and are not to be construed as a limitation of the disclosed solution.

As shown, the computing environment 250 illustrates one contemplated arrangement for a SIP application server 260. Voice user agent client (UAC) 254 and voice user agent server (UAS) 256 can be connected to server 260, as can registration UAC 252 and database 258. Within the SIP application server 260, one or more proxies 262 can support a set of nodes 264, 266 where each node 264, 266 can host one or more application servers. Each proxy 262 of the server 260 can support N nodes 264, 266. The nodes 264, 266 and proxies 262 can scale (generally SIP applications add capacity in a fairly linear manner) as desired to handle any SIP workload.

Node configuration 270 illustration shows a node 272, which has been vertically scaled, which is a practice of running more than one application server per node. Each application server 274, 275, 276 has a heap, which can handle a certain number of live sessions. Each application server instance 274, 275, 276 can be considered as adding memory capacity for hosting live SIP sessions. All other factors being equal, a node 272 running three application servers 274-276 has approximately three times the memory capacity for SIP sessions as a node 272 running on application server 274-276. Each application server can be a Java EE application server.

Vertical scaling (as shown by configuration 270) is situationally needed because increasing an application server's 274-276 heap size is not an effective way to accommodate additional SIP sessions. This results from a manner in with a Java EE application server performs garbage collection. Both garbage collection (GC) pause length and total GC activity tend to be directly proportional to heap size, which acts an inherent constraint on a maximum effective heap size per application server 274-276. Appreciably, adding application servers 274-276 per node can increase CPU overhead. When a memory constraint is more significant than a CPU constraint for an environment 250, a number of application servers 274-276 per node 272 can be increased for optimal memory. When a CPU constraint is more significant, a number of application servers 274-276 can be adjusted to reduce CPU overhead.

The diagrams in the FIGS. 1, 2, 3A, 3B, 3C, and 3D illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for capacity sizing a Session Initiated Protocol (SIP) application server comprising:
defining a SIP workload;
determining a number of nodes of a SIP application server needed to handle the SIP workload based upon memory considerations;
determining a number of nodes of the SIP application server needed to handle the SIP workload based upon CPU considerations; and
capacity sizing the SIP application server based upon a greater of the determined number of nodes based upon memory consideration and the determined number of nodes based upon CPU considerations.

2. The method of claim 1, further comprising:
determining a number of application servers running per node of the SIP application server based at least in part upon memory considerations, wherein the nodes specified during the capacity sizing of the SIP application server are based upon having the determined number of application servers running per node.

3. The method of claim 2, further comprising:
determining the number of application servers running per node of the SIP application server based at least in part upon CPU considerations, where CPU considerations favor a lower number of application servers running per node and where memory considerations favor a higher number of application servers running per node.

4. The method of claim 1, wherein the SIP application server is a cluster of physical servers comprising at least one proxy and a plurality of nodes, wherein each of the plurality of nodes runs at least one JAVA ENTERPRISE EDITION (Java EE) based application server, which handles a portion of the SIP workload.

5. The method of claim 1, further comprising:
vertically scaling at least a portion of the nodes when capacity sizing the SIP application server, wherein the vertical scaling results in at least a portion of the nodes running multiple JAVA ENTERPRISE EDITION (Java EE) based application servers, wherein the vertical scaling overcomes memory expansion constraints of a heap resulting from garbage collection overhead.

6. The method of claim 1, further comprising:
determining a number of nodes of a SIP application server needed to handle the SIP workload based upon memory considerations by:
computing a number of application servers that can be supported by a node due to memory constraints;
computing a number of SIP sessions supported per application server;
calculating a session capacity of a node based at least in part upon the number of application servers that can be supported and the number of SIP sessions supported per application server;
determining a node call rate that can be supported based at least in part upon the calculated session capacity and an average call hold time; and
dividing the call rate to be supported given the SIP workload by the determined node call rate in a computation that determines the number of nodes to handle the SIP workload based upon memory considerations.

7. The method of claim 1, further comprising:
determining a number of nodes of the SIP application server needed to handle the SIP workload base upon CPU considerations by:
scaling supported message throughput based upon hardware of the SIP application server;
computing needed SIP message per second throughput based at least in part upon a call rate to be supported given the SIP workload times and average number of SIP messages handled per call; and
dividing the needed SIP message per second throughput by the scaled supported message throughput in a computation that determines the number of nodes to handle the SIP workload based upon CPU considerations.

8. A computer program product for capacity sizing a Session Initiated Protocol (SIP) application server comprising a computer usable medium having computer usable program code embodied therewith, the computer usable program code comprising:
computer usable program code configured to detect a SIP workload;
computer usable program code configured to define a number of nodes of a SIP application server needed to handle the SIP workload based upon memory considerations;
computer usable program code configured to determine a number of nodes of the SIP application server needed to handle the SIP workload based upon CPU considerations; and
computer usable program code configured to capacity size the SIP application server based upon a greater of the determined number of nodes based upon memory consideration and the determined number of nodes based upon CPU considerations.

9. The computer program product of claim 8, further comprising:
computer usable program code configured to determine a number of application servers running per node of the SIP application server based at least in part upon memory considerations, wherein the nodes specified during the capacity sizing of the SIP application server are based upon having the determined number of application servers running per node.

10. The computer program product of claim 9, further comprising:
computer usable program code configured to determine the number of application servers running per node of the SIP application server based at least in part upon CPU considerations, where CPU considerations favor a lower number of application servers running per node and where memory considerations favor a higher number of application servers running per node.

11. The computer program product of claim 8, wherein the SIP application server is a cluster of physical servers comprising at least one proxy and a plurality of nodes, wherein each of the plurality of nodes runs at least one JAVA ENTERPRISE EDITION (Java EE) based application server, which handles a portion of the SIP workload.

12. The computer program product of claim 8, further comprising:
computer usable program code configured to vertically scale at least a portion of the nodes when capacity sizing the SIP application server, wherein the vertical scaling results in at least a portion of the nodes running multiple JAVA ENTERPRISE EDITION (Java EE) based application servers, wherein the vertical scaling overcomes memory expansion constraints of a heap resulting from garbage collection overhead.

13. The computer program product of claim 8, further comprising:
computer usable program code configured to compute a number of application servers that can be supported by a node due to memory constraints;
computer usable program code configured to compute a number of SIP sessions supported per application server;
computer usable program code configured to calculate a session capacity of a node based at least in part upon the number of application servers that can be supported and the number of SIP sessions supported per application server;
computer usable program code configured to determine a node call rate that can be supported based at least in part upon the calculated session capacity and an average call hold time; and
computer usable program code configured to divide the call rate to be supported given the SIP workload by the determined node call rate in a computation that determines the number of nodes to handle the SIP workload based upon memory considerations.

14. The computer program product of claim 8, further comprising:
computer usable program code configured to scale supported message throughput based upon hardware of the SIP application server;
computer usable program code configured to compute needed SIP message per second throughput based at least in part upon a call rate to be supported given the SIP workload times and average number of SIP messages handled per call; and
computer usable program code configured to divide the needed SIP message per second throughput by the scaled supported message throughput in a computation that determines the number of nodes to handle the SIP workload based upon CPU considerations.
